(19) United States
(12) Patent Application Publication
(10) Pub. No.: US 2022/0018566 A1
(43) Pub. Date: Jan. 20, 2022

(54) METHOD OF SAFE COMMISSIONING AND OPERATION OF AN ADDITIONAL BUILDING HVAC CONTROL SYSTEM

(71) Applicant: Brain4Energy Inc., Lewes, DE (US)

(72) Inventors: Andrei Kurganskii, Lewes, DE (US); Gleb Alshanskii, Lewes, DE (US)

(21) Appl. No.: 17/381,131

(22) Filed: Jul. 20, 2021

Related U.S. Application Data
(60) Provisional application No. 63/054,045, filed on Jul. 20, 2020.

(51) Int. Cl. F24F 11/63; F24F 11/49; G06N 20/00

(52) U.S. Cl. CPC F24F 11/63; F24F 2130/10; G06N 20/00; F24F 11/49

(57) ABSTRACT

The invention relates to computer engineering, more particularly, to the process of setting and training controllers of heating, ventilation and air conditioning systems. The technical result achieved by the proposed technical solution is to increase the accuracy of controlling HVAC system based on machine learning methods.

### CROSS REFERENCE TO RELATED APPLICATIONS

The present application claims priority to U.S. provisional Application No. 63/054,045, filed on Jul. 20, 2020, entitled “Method of safe commissioning and operation of an additional building HVAC control system,” which is incorporated by reference in its entirety.

### TECHNICAL FIELD

This technical solution relates to computer engineering, more particularly, to the process of setting and training controllers of heating, ventilation and air conditioning systems.

### BACKGROUND

Nowadays the problem of correct setting of heating, ventilation and air conditioning systems to more accurately control indoor climate with account of internal and external factors, such as change of weather, change of temperature, increase of humidity is fairly pressing.

The state of the art solutions make attempts to solve the problem of adapting to varying conditions by different methods, e.g. using preset scenarios or PID-controllers (proportional-integral-derivative controller).

The proposed technical solution relates to controlling the heating, ventilation and air conditioning (HVAC) equipment to generate optimal historical training data, more particularly, to the field of controlling HVAC system by means of machine learning models.

The proposed technical solution is aimed to increase the accuracy of controlling HVAC equipment of the building based on machine learning methods and to optimize the control, by, at least, one criterion (e.g., reduction of electric energy consumption, improvement of comfort, reduction of the cost of electric consumption, including selection of the electric energy source at different electric rates), including satisfaction of restrictions, more particularly, indoor microclimate conditions (e.g. temperate range indoors, delivery air pressure, CO2 level, etc.).

The proposed technical solution can be used to generate optimal historical training data consisting of setpoints (equipment control values) and readings of sensors (parameters) as response to setpoints during operation of HVAC equipment. The historical data are used to train machine learning models used to develop HVAC equipment control systems. Insufficiency of historical data can affect the level of training of the machine learning model, among other things, denying the system controlling the HVAC equipment with required accuracy and failure to fulfill microclimate conditions.

The object of the proposed technical solution is to increase the accuracy of controlling the building HVAC equipment control based on machine learning methods.

### SUMMARY OF THE INVENTION

The technical result achieved by the proposed technical solution is to increase the accuracy of controlling HVAC system.

One embodiment proposes a method of controlling the heating, ventilation and air conditioning (HVAC) control system wherein: metrics to determine accuracy of controlling the heating, ventilation and air conditioning (HVAC) equipment control system is selected; data on equipment parameters and setpoints are received from the building management system and saved in the equipment parameters and setpoints data base which also saves data sets from data generation controller generating optimal training data set of HVAC control after their generation; train the data generation controller and HVAC equipment control system employing the data from the equipment parameters and setpoints data base; put into operation the HVAC equipment control system; determine the value of current accuracy controlling the HVAC equipment control system depending on the selected metrics of computing the accuracy of controlling the HVAC control system and check sufficiency of accuracy of controlling the heating, ventilation and air conditioning (HVAC) equipment control system by means of preset threshold value; in response to the value of accuracy of (HVAC) equipment control system below the preset threshold value which corresponds to the sufficiency of accuracy of controlling the HVAC equipment control system, continue receiving the data on equipment parameters and setpoints from the building management system and data generation controller and save them in data base of equipment parameters and setpoints; in response to the value of accuracy of controlling the HVAC equipment control system above the preset threshold value which corresponds to the insufficiency of accuracy of controlling the HVAC equipment control system perform the following steps until the required value of accuracy of controlling the HVAC equipment control system is achieved: select the type of distribution and distribution parameters for the target variable requiring optimization: remove from operation the HVAC control system; put into operation the data generation controller and using the data generation controller generate optimal training data achieving the quantity and composition of the target variable in the generated data according to the selected distribution type and parameters of the target variable, after this the data generation controller is put out of operation; machine learning models of HVAC control system are additionally trained on all data from the parameters and setpoints data base; additionally trained HVAC equipment control system is put into operation and the value of accuracy of controlling the HVAC equipment control system is put into operation and the value of accuracy of controlling the HVAC equipment control system is determined depending on the selected metrics and sufficiency of accuracy of controlling the HVAC equipment control system is checked by means of preset threshold value, if, at that, the value of accuracy of controlling the HVAC equipment control system is below the preset threshold value the equipment parameters and setpoints data continue to be received from the building management system and data generation controller and saved in the equipment parameters and setpoints database, and if the value of accuracy of controlling the HVAC equipment control system is above the threshold value these equipment parameters and setpoints are synthesized.

In one specific embodiment the metrics is the integrated time of violation of preset restrictions of the system control parameter values. The metrics, at this, depends, at least, on the building and equipment parameters.

In one specific embodiment the metrics is the mean time of violation of control restrictions within preset time interval. The metrics, at this, depends on, at least, the building and equipment parameters.

In one specific embodiment in the absence of parameters and setpoints data of the equipment the time to generate these parameters and setpoints of the equipment is increased.

In one specific embodiment the heating, ventilation and air conditioning control system is trained using methods of Model Predictive Control or Reinforcement Learning or systems of equation describing, at least, operation of each equipment unit, the data of weather and thermophysical processes.

In one specific embodiment the data to train the heating, ventilation and air conditioning equipment control system are generated using predictive model (Model Predictive Control), where the predictive model implementing machine learning using classifier or decision trees or regression equations is learning on the data from parameters and setpoints database or is made in the form of system of equations describing operation of each operation unit, weather data and thermophysical processes.

In one specific embodiment the generation of dataset optimal for training the heating, ventilation and air conditioning equipment control system at each time step includes: selection or presetting of the matrix containing information about target variable intervals and quantity of values for the intervals which should be collected during generation of optimal training data, receiving of current equipment parameters, generation of set of setpoint versions in the preset neighborhood of setpoint values forming the setpoints combinations grid to further predictively check the optimality; for each version of setpoints forming the predicted equipment parameters when using the predictive model the following is done: the predicted equipment parameters formed when using each of the versions of generated setpoints are determined, setpoints from the set of generated versions of setpoints at which the predicted equipment parameters satisfy the microclimate restrictions and\or equipment parameters, and at which the pair rule version and current parameters is not available in the parameters and setpoints data; optimal training settings from those selected at the previous step by taking a random value using uniform, normal or exponential random values distribution law are determined; determined optimal training equipment setpoints are used; the pair optimal training rule and current parameters are added to the given equipment parameters and setpoints are used, necessity of generating optimal training data representing the check of the composition of target variable preset in the matric containing information about the target variable intervals and the quantity of their values is checked.

In one specific embodiment at each time step after using the optimal setpoints the quantity of values of the target variable predicted by use of optimal setpoints determined at the current time interval, of matrix containing information about the target variable intervals and the quantity of values for the intervals is decremented.

In one specific embodiment to determine the predicted equipment parameters formed in the use of each version of generated setpoints the value of certainty in predicted data is generated and optimal training setpoints are determined by selection of setpoints at which the predicted equipment parameters will satisfy the microclimate conditions and/or by equipment parameters at which the smallest value of certainty in predicted data is generated.

### BRIEF DESCRIPTION OF THE DRAWINGS

FIG. 1 shows a model version of the interaction pattern of HVAC equipment control system, building management system (BMS) and HVAC equipment according to one embodiment of the invention;

FIG. 2 shows a model version of one embodiment of this invention;

FIG. 3 shows a model version of one embodiment of the process of selecting optimal values in real time during operation for one loop;

FIG. 4 shows an example of breaking down the target variable for optimization according to one embodiment of the invention;

FIG. 5 shows a model version of generation in the case when the filling is excessive according to one embodiment of the invention;

FIG. 6 shows another model version of generating optimal data according to one embodiment of this technical solution;

FIG. 7 shows a model version of embodiment of the invention;

FIG. 8 shows an example of general purpose computer system

### DETAILED DESCRIPTION

The subjects and features of this technical solution, methods of achieving this subject and features may become apparent by referencing to model embodiments. However, this technical solution is not limited by model embodiments disclosed below, it can be embodied in different forms. The essence given in the description is nothing else but specific details provided to help a person skilled in the art to fully understand the technical solution, and this technical solution is determined only within the scope of the attached formula.

Terms “module”, “component”, “element” and the like are used to denote computer essences which can be hardware/equipment (e.g. a device, tool, apparatus, equipment, component of device, e.g. a processor, microprocessor, integrated circuit, circuit board, including electronic circuit board, breadboard, motherboard, etc., microcomputer and so on), software (e.g. executed software code, compiled application, file, program/application, function, method, (programming) library, subprogram, co-program and/or computing device (e.g. microcomputer or computer) or a combination of software and hardware components.

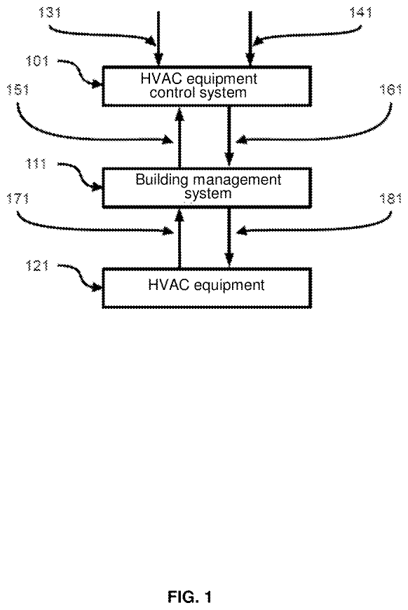

FIG. 1 shows a model version of interaction pattern of the HVAC equipment control system, building management system and HVAC equipment.

The HVAC equipment control system 101 computes optimal control values (setpoints) for HVAC equipment 121 and employs them by means of building management system (BMS) 111, which in its turn, at least, monitors the entire automation system of the building, in particular, is designed to automate processes and operations implemented in modern buildings, to denote it term BACS (building automation and control system) is frequently used as a system to automate engineering systems or life support systems of the building: ventilation, heating and conditioning, water supply and sewage, electric power supply and illumination. BMS 111 sends the setpoints (transmits the setpoints) of each HVAC equipment unit, more particularly, BMS is a means to use the setpoints and read building equipment parameters. In a particular case, BMS acts as an interface to exchange the data between the control system and HVAC equipment. Originally BMS itself controls the setpoints of HVAC equipment, but does it not optimally, but according to the schedule. In this connection there exist state-of-the-art solutions—pluggable external control systems. So, the means of HVAC equipment control system 101 compute, among other things, optimal values, of control (161 and 181) for HVAC equipment 121 which may be the values of temperature, e.g. temperature of air conditioning unit, opening of the fan shutter, air flow value, etc., control (optimal) values 161 and control (optimal) values 181 may be identical, i.e. the control (optimal) values 161 may not change after they are transmitted by the HVAC equipment control system 101 to the building management system 111 during their transmission, more particularly, (optimal) control values 161 are not changed by the building management system 111 in the transmission process. The optimality of the mentioned control values can be defined by determined, particularly, earlier preset criteria, e.g. minimization of energy consumption with observation of comfortable temperature, humidity, CO2 level indoors.

The input data 131, in particular, available historical data on parameters (particularly, the sensor readings) and setpoints (particularly, the control values) of HVAC equipment 121 prior to putting into operation of the HVAC equipment control system 101, based on machine learning models may be insufficient to train machine learning models to certain (preset, selected) accuracy (e.g. 85 percent, 90 percent and so on, including depending on the stated problems, requirements, among them—to accuracy etc.). HVAC equipment 121 may be, e.g. conditioning units, shafts, shutters, valves, radiators, fan coils, etc. The mentioned sensors may be sensors of temperature, air flow, water flow, humidity, CO2. In a particular case, a part of sensors monitors correct operation of equipment, the other part—observation of microclimate conditions indoors. The mentioned putting into operation of HVAC equipment control system 101, is connection of external system translating BMS settings 111, e.g. connection of the control server (servers) to BMS 111. The historical data on parameters and setpoints are stored, at least, in one data storage, the data wherein are updated by (in which the data are written) by BMS 111. Such a data storage can be connected, at least to BMS (or can be a part of BMS) and can be connected with HVAC equipment 121, HVAC equipment control system 101, control servers (of the external system) or be their part.

Within the framework of this technical solution the historical data are used to train machine learning models, the insufficiency of sampling of historical data, affects, at this, the level of training the machine learning model (e.g. if the sampling is small, the sufficient selected accuracy, e.g. 80 percent, or 90 percent is not achievable), denying the HVAC equipment control system 101 the possibility to control HVAC equipment 121 with required accuracy resulting in non-observance of microclimate conditions, particularly, the parameter values within preset limits equal to preset values, etc. (e.g. it is required, in particular, to maintain in the offices comfortable temperature from 20 to 23 degrees), e.g. temperature range in the rooms, pressure of delivered air, CO2 level, etc.

HVAC equipment 121 is controlled by data generation controller (HVAC control controller) which can be such computing device as computer, server, etc. with installed software which during operation selects setpoints of HVAC equipment 121, at which the setpoints-parameters pairs are optimal for training, maintaining (observing), at this, restrictions (particularly, those preset) of microclimate conditions in building 141 rooms. The setpoints are selected by the data generation controller proceeding from the optimality criteria and current condition of the system and external conditions (weather, rates and visitation level)

In a particular case, the restrictions of microclimate conditions in building 141 rooms are determined in compliance with regulatory documents, e.g. of ISO 17772 standard series or the like. These restrictions may be temperature, humidity, CO2 level values.

The data, in particular, input data 131 and restrictions of microclimate conditions in building 141 rooms are transmitted from the servers (in a particular case, specialized ones) or can be preset by the user (administrator, etc.) by means of data input device. E.g. input data 131, e.g. weather data can be received by HVAC equipment 101 system from the services of weather data provisioning servers, e.g. «Gismeteo», or can be preset (in particular, entered by means of data input device, such as the keyboard) by the user, including those received from weather statistics averaged over several recent years (months, etc.): the rate data can be received from the web-service server providing them; restrictions can be preset (entered) by the user, e.g. operators, engineers or other personnel adjusting the HVAC equipment 101 control system or building management system 111, or HVAC equipment 121 or adjusts their totality.

The data (131, 141, 151) are transmitted into HVAC equipment 101 control system e.g. in the form (format) of vector (or dictionary) of values. Transmitted into HVAC equipment 101 control system (in particular, received) are input data (external data, such as weather, rates, visitation level, in particular the values of weather, rates, visitation level, etc.) 131, restrictions of microclimate conditions in the building rooms (in particular, restrictions on the issued setpoints) 141 and current HVAC parameters 151.

Current HVAC parameters 151 and current HVAC parameters 171 may be identical, i.e. current HVAC parameters 151 and current HVAC parameters 171 may not change after their transmission by building management system 111 to the HVAC equipment control system 101, in particular, current HVAC parameters 151 and current HVAC parameters 171 are not changed by building management system 111 in the process of their transmission. Thus, examples of current HVAC parameters 151 and current HVAC parameters 171 may be temperature of office number one (No 1), humidity in office number two (No 1), CO2 level in office number one (No 1), etc. for different rooms, in particular, values of temperature, humidity, etc., and parameters of various HVAC instruments.

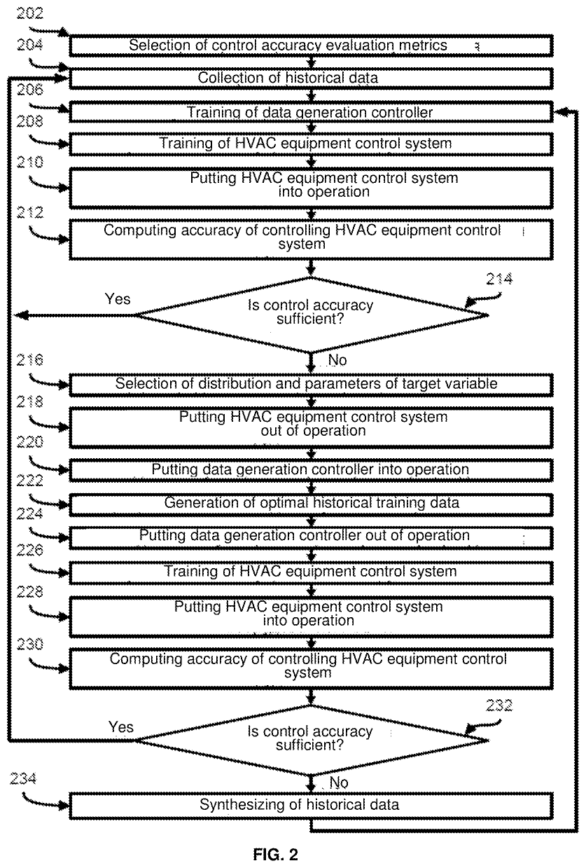

FIG. 2 shows a model version of one of the embodiments of this invention.

Steps 202, 204, 206, 208, 210, 212, 214, 216, 218, 220, 222, 224, 226, 228, 230, 232, 234, shown in FIG. 2 are performed by the data generation controller which is part of HVAC equipment control system 101.

At step 202 metrics of computing (evaluating) accuracy of controlling HVAC equipment control system 101 is selected. In different embodiments the metrics can be defined as integral time of violation of control restrictions (such as temperature and CO level in the room, flow rate, air pressure) or as mean time of violations of control restrictions per hour/day/week, or any similar method, each metrics, as a rule, depends, at this, at least, on the building (and its parameters, equipment, etc.).

At step 204 available historical data of parameters and setpoints of HVAC equipment 121 are collected. In a particular case, all available historical data of parameters and setpoints are collected. In the absence of those, the generation period may be different—week, month, months, etc. which depends on the building, control resolution and season of the year, and, in particular, case can be determined empirically.

At step 206 the controller (data generation controller) generating optimal historical training data is trained.

At step 208 HVAC equipment control system 101 is trained which can be based on Model Predictive Control, Reinforcement Learning methods or HVAC equipment control system 101 is generated (in particular, equation systems describing operation of each equipment unit, weather and thermophysical processes and other factors are selected) which can be based on equation systems.

At step 210 HVAC equipment control system 101 is put into operation, in particular, the server generating BMS setpoints is connected.

At step 212 current accuracy of controlling HVAC equipment control system 101 is computed.

The accuracy of controlling HVAC equipment control system 101 in different embodiments of this technical solution can be defined as integral time of violation of control restrictions (such as temperature and CO2 level in the rooms, flow rate, air pressure) or as mean time of violation of control restrictions per hour/day/week, or by other method.

According to the embodiment of invention optimal historical training data are generated on the basis of control method with predictive model. When implemented by machine learning algorithms (classifier, decision tree, regression equations) the predictive model is trained on available historical data or can be implemented in the form of a system of equations (e.g. system of differential equations, ordinary differential system, classical finite-dimensional linear system of controlled differential equations, etc.) describing operation of each equipment unit, weather and thermophysical processes and other factors and in a particular case depend on specific equipment, buildings and processes in them.

At step 214 sufficiency of accuracy is checked, at this, depending on the metrics is numerical value is calculated (e.g. integral time of violation of comfort conditions). If it is above the threshold (e.g. the whole day) the accuracy is insufficient.

If at step 214 the accuracy is found to be sufficient, then the pass over to step 204 is performed.

If at step 214 the accuracy is found to be insufficient, then the pass over to step 216 is performed at which the distribution type and distribution parameters for the target variable are selected. Then, at step 218 HVAC equipment control system 101 is put out of operation, in particular, the setpoints generating server is disconnected from BMS. At step 220 the controller (data generation controller) which such a computing device as computer, server, etc., with installed software and generating optimal historical training data, is put into operation. During operation of the controller (data generation controller) at step 222 by means of the controller (in particular, by the controller) optimal historical training data are generated to achieve the quantity and composition of the target variable in the generated historical data according to the selected type and parameters of distribution of the target variable. E.g. to distribute historical data of the target variable—temperature in the office—it is required to fill in compliance with uniform distribution one hundred (100) values of the target variable for each one (1) degree interval from twenty to twenty seven (from 20 to 27) degrees. Or normal distribution with parameters mathematical expectation 23 degrees plus or minus (±) 3 degrees (mean-square deviation) can be used, the cases of target variable equal to mathematical expectation should be not less than 100, the other values are computed by the distribution formula. Then, at step 224 the controller (data generation controller) is put out of operation, at step 226 the machine learning model of HVAC equipment control system is additionally trained on all available historical data, at step 228 additionally trained HVAC equipment control system 101 is put into operation, and at step 230 the current accuracy of controlling the HVAC equipment control system 101 is computed. At step 332 sufficiency of control accuracy is checked, provided the accuracy is sufficient pass over to step 204 is performed, and in case of insufficient accuracy pass over to step 234 is performed, at which historical data are synthesized (in a particular case the generation is performed «naturally» by the entire HVAC system, and synthesizing—without participation of the building, equipment and any systems), in particular,
by mathematical treatment (SMOTE, SMOTEN, ADASYN, SVMSMOTE, BorderlineSMOTE, KMeansSMOTE, SMOTENC haps://imbalanced-learn.org/stable/references/generated/imblearn.over_sampling.SMOTE.html) additional historical data are synthesized,
the machine learning model of HVAC equipment control system 101 is additionally trained on all available (generated, synthesized and available) historical data,
the additionally trained HVAC equipment control system 101 is put into operation and
current accuracy of controlling HVAC equipment control system 101 is computed, after that return to step 206 is performed. In this manner, when the accuracy of controlling is insufficient, the cycle of putting the data generation controller into operation (steps 216-234, FIG. 2) is repeated by connecting the setpoints generation server, generating additional historical data and additional training to achieve required accuracy of controlling the HVAC equipment control system 101.

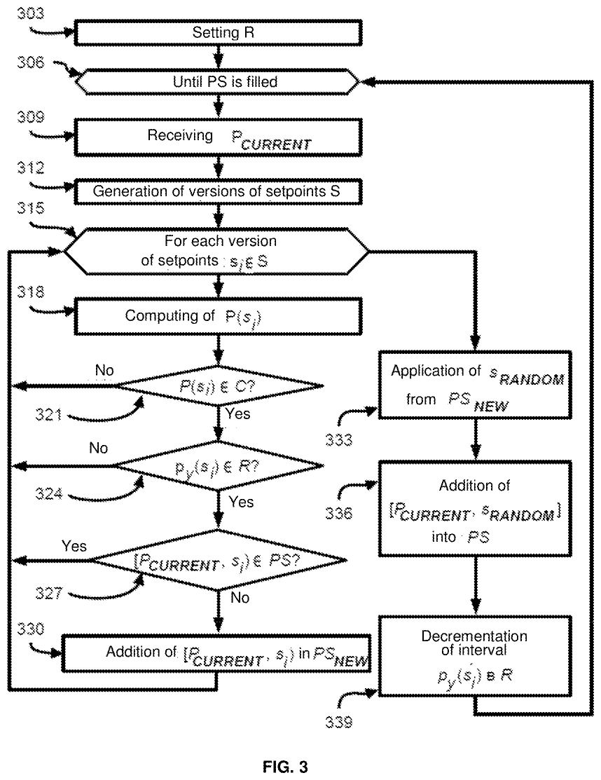

FIG. 3 shows one of model embodiments of optimal values selection process in real time during operation for one loop.

Each loop is, at least, one or several rooms and HVAC equipment responsible for the microclimate in these rooms. E.g. a floor and one big air conditioning unit supplying air to the rooms on the floor. Connected to the conditioning unit can be various HVAC equipment (e.g. radiators, shutters, water cooler, rooftops, etc. which heat/cool the air passing through the conditioning unit for the rooms). In a a particular case, each loop is matched with one target variable—e.g. temperature in the room or average temperature in the rooms of the loop.

As shown in FIG. 3 until PS (historical data) are not filled (306) in the course of operation (in particular, corresponding to step 222, FIG. 2) at each time step (where the value of the time step in a particular case is more or equal to one minute, e.g. one minute, five minutes, ten minutes, fifteen minutes, thirty minutes and so on, among them in connection with the fact that the heat exchange processes do not have high rate) current parameters (151, 171) of HVAC equipment (P_{current}) are received (309) and in a certain neighborhood of values of current setpoints (which in a particular case are selected empirically) a set of setpoints version is generated (S=[s₁, s₂, . . . , s_{W}]) at step 312 (corresponding, in particular, to step 222, FIG. 2), in particular, created is a combinations grid of setpoints versions which are then predictively checked for optimality. The mentioned receiving (309) of current parameters (151, 171) of HVAC equipment (P_{current}) is performed by the HVAC equipment control system 101 through the building management system 111 (which in a particular case is used as the data exchange interface). The swing of the grid for each setpoint is set (in a particular case selected empirically) in the vicinity of admissible and critical (restrictions of microclimate and/or equipment parameters) values of setpoints. PS is filled to the value equal to the sum of the quantity of available historical data necessary to complement the available in a way to obtain optimal quantity of historical training data.

For each version of setpoints sᵢ∈S (315) by means of the predictive model computed are future (the predictive model forecasts/predicts what will be the system/equipment parameters if some combination of setpoints is used) parameters of HVAC equipment (P(sᵢ) 318) 121, which will form in the use of each of versions of generated setpoints. From the set of generated versions of setpoints S selected are those which generate pairs of optimal training parameters and HVAC equipment (versions of selecting optimal setpoints are described below) satisfying, at that, the restrictions of microclimate conditions.

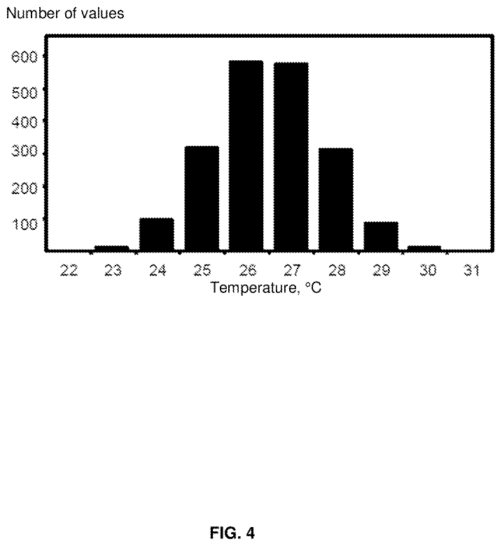

To generate optimal historical training data tables of PS historical data are set by the number of lines (an example of a table is described below, including sixty readings of temperature sensors, fifty six readings of pressure sensors, and so on; in this format historical data can be stored, e.g. when the system is started ten thousand lines of historical data are stored which are insufficient for training, in this connection ten thousand lines more are required and optimal historical data are collected by means of putting in the controller). For this the range of each target (the target can be maintaining optimal conditions of the building rooms; the target variable—e.g. temperature in this room) to optimize the variable is broken down into intervals (selected, in particular, empirically) and for each such interval preset is the quantity of values which are to be generated in the course of generation of optimal training data. The quantity of such values of the target for optimization variable (target variable) can be set in accordance with known distributions of random value—ordinary, uniform, exponential, etc.—depending on the nature of the target variable where distribution and its parameters, in a particular case, are selected empirically. An example of breaking down target for optimization variable is shown in FIG. 4.

In case of insufficient accuracy of training the process of generating optimal training data is repeated with changed quantity and composition of distribution or changed type of distribution and its parameters.

As shown in FIG. 3, at step 303 matrix R is set (in particular, required number of lines and exactly which lines are required, in particular, what specific values of target variable and in what quantity are to be collected) of size K×L (where K and L, in a particular case, are selected empirically) containing information about intervals and quantities of values for the intervals, in particular, R contains data about the quantity of elements which are to be filled. Each element R can be set in the form of vector of two numbers:

rᵢ=[v,n],

where
v is the target variable value;
n is quantity of values of the target variable interval v to be collected.
   E.g. matrix R can be set as

$$R = [ \begin{matrix}23 & 100 \\ ⋮ & ⋮ \\ 27 & 100\end{matrix} ]$$

The number of lines of the matrix of generated historical data is, thus, selected as resulting number of values of target for optimization variables required for generation, in particular, all required for generation values of all target for optimization variables:

$${N}_{ROWS} = {\sum }_{i = 0}^{K} {R}_{i , 1}$$

where R_{i,1} is the number of values of the i^{th} value of the target variable.

According to one embodiment of this technical solution the optimal setpoints (sₒₚₜ_{ₜ}₋) at each time step (t) are calculated by taking random (uniformly, normally, exponentially or by other random values distribution law) value from the array of setpoints (combination grid), HVAC equipment parameters 121 at which microclimate conditions satisfy restrictions (P(sᵢ)∈C, step 321), are not contained in the available PS historical data ([P_{CURRENT},sᵢ]∉PS, step 327), and the quantity of values for the target variable interval is not filled for the predicted value of the target variable [symbol] _{y} [symbol] _{y}(sᵢ)∈R, step 324):

sₒₚₜ_{ₜ}=s_{RANDOM}=rand(arg(PS_{NEW})),

subject to P(sᵢ)∈C (step 321), i.e. this is a check of predicted parameters of the system to satisfy the restrictions
[symbol] _{y}(sᵢ)∈R (step 324);
[P_{CURRENT},sᵢ]∉PS (step 327)
   where
PS_{NEW} is a set of vectors of setpoints and predicted parameters,
S_{RANDOM} is a randomly taken value from such values of the combination grid which satisfy restrictions,
[symbol] _{y}(sᵢ) is the future value of the target variable when using a combination of setpoints (sᵢ).
   The set of vectors of parameters and setpoints of available PS historical data comprises sets of parameters and setpoints for different discrete time moments (e.g. every 10 minutes) and can look as follows for L time moments:

$$[ {{[ {T}_{1} , … , {T}_{60} , {P}_{1} , … , {P}_{56} , {F}_{1} , … , {F}_{14} ]}_{1} ; \\ [ {T}_{1} , … , {T}_{60} , {P}_{1} , … , {P}_{56} , {F}_{1} , … , {F}_{14} ]}_{2} ; … ; {[ {T}_{1} , … , {T}_{60} , {P}_{1} , … , {P}_{56} , {F}_{1} , … , {F}_{14} ]}_{L} ] ,$$

where T₁, . . . , T₆₀ are the readings of temperature sensors (parameter) in the building, e.g. of sixty sensors (or ten sensors and so on), P₁, . . . , P₅₆ are the readings of 56 sensors of supplied air pressure (parameter) in the building, F₁, . . . , F₁₄ are the values of setting of the air flow rate from 14 inlet ventilation units. For the real building systems PS vector has several scores of parameters and setpoints.

E.g. after step 218 pass over to step 321 is performed.

If at step 321 it was found that P(sᵢ)∈C, then pass over to step 324 is performed. Otherwise, pass over to step 315 is performed.

If at step 324 it was found that p_{y}(sᵢ)∈R (the value of target variable is present in R and required quantity has not been collected), then the pass over to step 327 is performed. Otherwise, pass over to step 315 is performed.

If at step 327 it was found that [P_{CURRENT},sᵢ]∈PS, then pass over to step 315 is performed.

At step 330 addition to [P_{CURRENT}, sᵢ] in PS_{NEW} is made and pass over to step 315 is performed.

At step 333 from PS_{NEW} randomly is selected s_{RANDOM}, and vector [P_{CURRENT},s_{RANDOM}] is entered (added) into the list of historical data of PS parameters and setpoints at step 336, into historical data are entered (and saved) vectors of current parameters and setpoints which accordingly were used at specific discrete time moment. Into the interval value of matrix R_{i,j} corresponding to the target variable preset by the distribution decremented (decreased by 1) at step 339 (in particular, traced is how many else should be filled, i.e. per one less that remained to be filled), after that the process returns to step 306.

FIG. 4 shows an example of partition (in a particular case the number is selected empirically) of target for optimization variable according to one embodiment of this invention.

As described above if additional data are found to be necessary (e.g. ten thousand lines of historical data) such data should contain useful, but not random information. If the additional data describe the target variable the optimal training data set will be collected.

As the target temperature is limited, e.g. from twenty one to thirty degrees and the law used is uniform, it is required to collect one thousand lines of historical data for the target temperature values for each degree.

E.g. in the process of collection over a certain time interval (e.g. week, month) it is required to generate one thousand lines of historical data for the target temperature value equal to twenty three degrees, which is sufficient for the said temperature value (and not to select twenty three degrees in the process of selecting optimal values in real time in the process operation for one loop shown in FIG. 3).

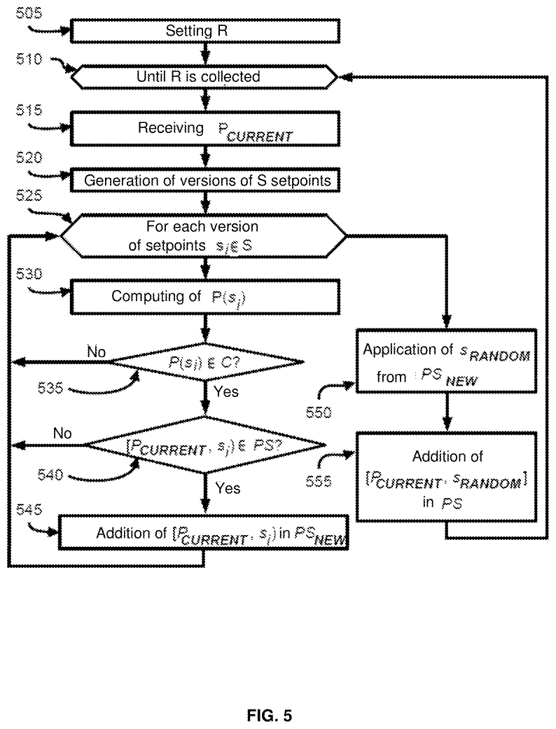

FIG. 5 shows a model version of generation in the case where filling is done excessively, according to one embodiment of the invention.

At step 505 matrix R is set (or selected) (in particular required number of lines and which exactly lines are required, in particular which specific values of the target variable and its quantity it is required to collect), in a particular case the size of the matrix is set and further on it is filled, in particular, in random manner, without repetitions, at that.

In a different embodiment of technical solution until R is not collected (510) in the course of operation at each time step current parameters of HVAC equipment 121 (P_{current}) are obtained (515) and a set of versions of setpoints (S=[s₁, s₂, . . . , s_{W}]) at step 520 in a certain (preset) neighborhood of values of current setpoints is generated. Thus, proceeding from the above example for each value of uniformly distributed target value ten thousand historical data are required. But, as the optimal value is selected at step 505 randomly, very many repetitions of the target variable will be obtained, which will be added to the historical data, however the generation will be completed under condition when minimum thousand lines per each degree of the target variable from twenty one degree to thirty degrees are collected. Thus, as the parameters are very numerous, then in numerous repetitions of the target variable the whole vector of «setpoints plus parameters» will repeat seldom (in a particular case, can be disposed of at step 540 at which complete coincidence of the vector is checked, and not by the target variably only, i.e. if the full coincidence of the vector is established, such a vector is not used), and because of this excess the historical data will be diverse.

For each version of setpoints sᵢ∈S (525) by means of predictive model future parameters of HVAC equipment 121 (P(sᵢ)), which will arise in application of each version of generated setpoints, are computed at step 530. From the set of generated versions of setpoints S selected are such (selection of optimal setpoints consists of several steps: 535, 540, 550) which generate (in particular, the data generation controller generates such pair of parameters which will be optimal) optimal training pair of parameters and setpoints of HVAC equipment 121, satisfying, at that, restrictions of microclimate conditions.

To generate optimal training historical data the number of lines of the PS historical data table are set. For this the range of each target for optimization variable is partitioned into intervals, and for each such interval the number of values to be generated in the course of generation of optimal training data is set. The number of target variable values can be set in accordance with known distributions of random value—normal, uniform, exponential, etc. depending on the nature of the variable (target variable, target for optimization variable).

Optimal setpoints (sₒₚₜ_{ₜ}) at each time step (t) are computed by taking random value (according to uniform, normal, exponential or according to other random value distribution law) from the array of setpoints (in particular, the combination grid), HVAC equipment parameters 121 at which the restrictions of microclimate conditions (P(sᵢ)∈C are satisfied, step 535), and are not contained in available PS historical data ([P_{CURRENT},sᵢ]∉PS, step 540):

sₒₚₜ_{ₜ}=s_{RANDOM}=rand(arg(PS_{NEW})),

subject to P(sᵢ)∈C (step 535)), i.e. this is a check of predicted parameters of the system to satisfy the restrictions;

[P_{CURRENT},sᵢ]∉PS (mar 540).

After application of new setpoints vector [P_{CURRENT}, S_{RANDOM}] is put into the list of historical data of PS parameters and setpoints. Then, accordance of the composition of data of the target variable to preset distribution is checked. In the case when the composition of the data of the target variable is not collected the iteration is repeated. Otherwise the historical optimal training data are considered to have been collected in required quantity.

So, if at step 535 is was found that P(sᵢ)∈C, pass over to step 540 is performed. Otherwise, pass over to step 525 is performed.

If at step 540 it was found that [P_{CURRENT},sᵢ]∈PS, pass over to step 545 is performed. Otherwise, pass over to step 525 is performed.

At step 545 addition to [P_{CURRENT}, sᵢ] in PS_{NEW} is made and pass over to step 525 is performed.

At step 550 S_{RANDOM} is randomly selected from PS_{NEW} and at step 555 [P_{CURRENT}, s_{RANDOM}] is added to PS, after that the process returns to step 510.

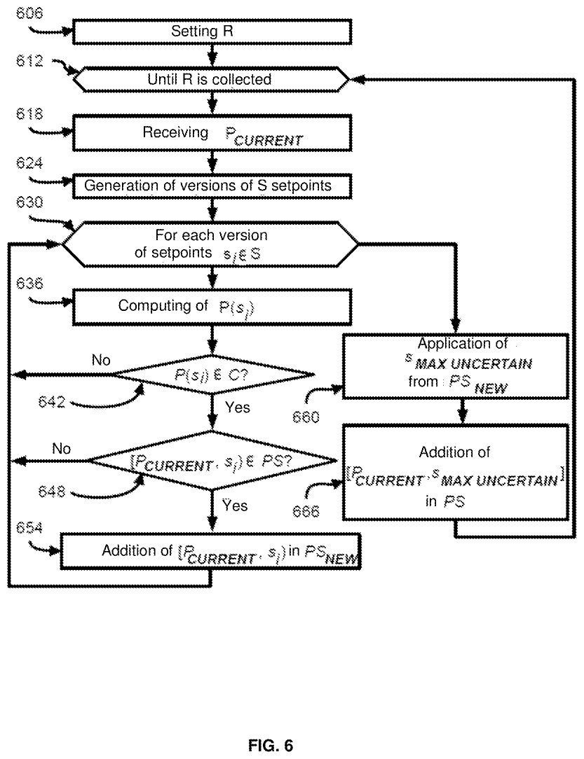

FIG. 6 shows another model version of optimal data generation, according to one of embodiments of this technical solution.

At step 606 matrix R is set (or selected) (in particular required number of lines and which specifically lines are required, in particular which specific values of the target variable and in what quantity are to be collected), so, in a particular case the size matrix is set and then it is filled, in particular, randomly, with repetitions, at that.

In another embodiment of this technical solution until R is not collected (612) in the course of operation at each time step current parameters of HVAC equipment 121 (P_{current}) are obtained (618) and a set of versions of setpoints (S=[s₁, s₂, . . . , s_{W}]) at step 624 in a certain (preset_neighborhood of values of current setpoints is generated.

For each version of setpoints sᵢ∈S (630) by means of predictive model future parameters of HVAC equipment 121 (P(sᵢ)) at step 636 are computed which will arise in application of each of the versions of generated setpoints. From the set of generated versions of S setpoints such are chosen (steps 642, 648, 660) that generate pairs of optimal training parameters and setpoints of HVAC equipment 121 satisfying, at that, restrictions of the microclimate conditions.

Optimal historical training data are generated on the basis of control method with predictive model (MPC) capable of additionally generating the value of certainty in predicted data. The optimal setpoints (sₒₚₜ_{ₜ}) at each time step t are computed by taking a value from the array of setpoints with the smallest degree of certainty, but HVAC equipment parameters at which restrictions of microclimate conditions (P(sᵢ)∈C) are satisfied and are not contained in available historical data ([P_{CURRENT},sᵢ]∉PS):

sₒₚₜ_{ₜ}=s_{MAX UNCERTAIN}=argmax(uncertainty(PS_{NEW})),

subject to P(sᵢ)∈C;

[P_{CURRENT},sᵢ]∉PS.

E.g., if at step 642 it was found that P(sᵢ)∈C, then, pass over to step 648 is performed. Otherwise, pass over to step 630 is performed.

If at step 648 it was found that [P_{CURRENT},sᵢ]∈PS, then pass over to step 654 is performed.

At step 654 addition in [P_{CURRENT}, sᵢ] in PS_{NEW} is made and pass over to step 630 is performed.

At step 660 setpoints with smallest degree of certainty s_{MAX UNCERTAIN} are selected from PS_{NEW} and at step 666 [P_{CURRENT}, s_{MAX UNCERTAIN}] is added to PS, after that the process returns to step 612.

In another embodiment of this technical solution the predictive model predicts not accurate parameters of HVAC equipment 121 P(sᵢ), and their possible intervals P_{±Δ}(sᵢ) (e.g. when using neural network to model Gaussian processes) which arise in application of each of the versions of generated setpoints. The optimal setpoints are computed in analogy with above described methods, but with satisfied restrictions of microclimate conditions for predicted intervals P_{±Δ}(sᵢ)∈C.

After generation of optimal historical training historical training data, the HVAC equipment control system 101 is additionally trained and put into operation. Then the control accuracy is computed again. If, at this stage the accuracy is insufficient the historical data are synthesized using mathematical methods analogous to Oversampling, SMOTE (Synthetic Minority Oversampling Technique), SMOTEN, ADASYN, SVMSMOTE, BorderlineSMOTE, KMeansSMOTE, SMOTENC, ASMO whose description is available among other things at link https://basegroup.ru/community/articles/imbalance-datasets or other.

After the optimal training historical data are synthesized HVAC equipment control system 101 is additionally trained, put into operation and accuracy of control is computed. If the control accuracy again does not satisfy that preset at the initial stage the cycle of putting the data generation controller into operation and data synthesizing are repeated with changed type and/or parameters of target variable distribution and/or parameters of synthesizing historical data.

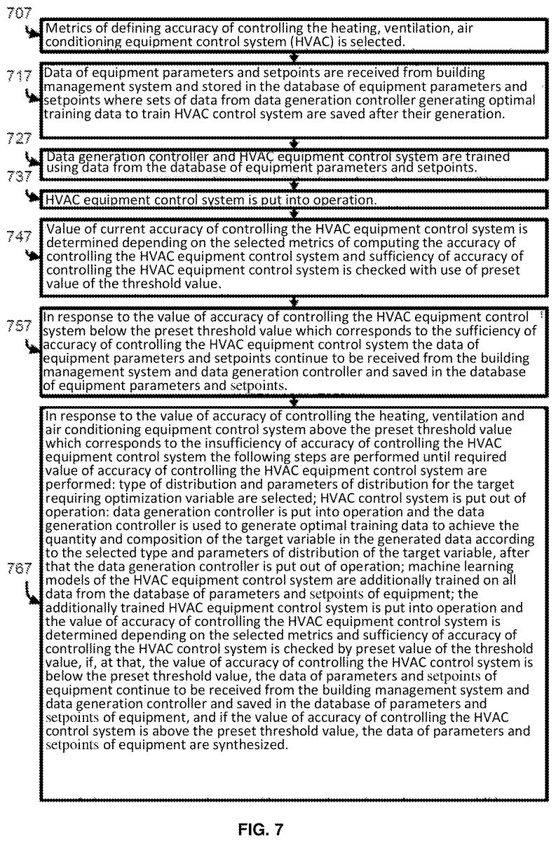

FIG. 7 shows one of embodiments of this invention.

At step 707 metrics of determining accuracy of controlling the heating, ventilation and conditioning (HVAC) equipment are selected.

At step 717 data of equipment parameters and setpoints are received from the building management system and stored in the database of equipment parameters and setpoints, which also stores sets of data from the data generation controller generating optimal training data for the HVAC control system after their generation.

At step 737 HVAC equipment control system is put into operation.

At step 747 the value of current accuracy of controlling the heating, ventilation and conditioning (HVAC) equipment control system is determined depending on the selected metrics of computing the accuracy of controlling the heating, ventilation and conditioning equipment control system and sufficiency of accuracy of controlling the heating, ventilation and conditioning equipment control system is checked by means of preset value of the threshold value.

At step 757 in response to the value of accuracy of controlling the HVAC equipment control system below the preset threshold value which corresponds to the sufficiency of accuracy of controlling the HVAC equipment control system the data of equipment parameters and setpoints continue to be received from the building management system and data generation controller and saved into the database of equipment parameters and setpoints.

At step 767 in response to the value of accuracy of controlling the HVAC equipment control system above the preset threshold value which corresponds to the insufficiency of accuracy of controlling the HVAC equipment control system the following steps are made until the required values of the accuracy of controlling the HVAC equipment control system is reached: distribution type and parameters of distribution for the target requiring optimization variable are selected; HVAC control system is put out of operation; data generation controller is put into operation and using the data generation controller generates optimal training data with achievement of the quantity and composition of the target variable in the generated data according to the target value selected by the type and parameters of the target variable, after that the data generation controller is put out of operation; the machine learning models of the HVAC equipment control system are additionally trained on all data from the database of parameters and setpoints of the equipment; additionally trained HVAC equipment control system is put into operation and the value of accuracy of controlling the HVAC equipment control system is determined depending on the metrics selected and sufficiency of accuracy of controlling HVAC equipment control system is checked by means of preset value of threshold value, and if the value of accuracy of controlling the HVAC equipment control system is below the preset threshold value, then the data of equipment parameters and setpoints continue to be received from the building management system and data generation controlled and stored in the dataset of equipment parameters and setpoints, and if the value of accuracy of controlling the HVAC equipment control system is above the preset threshold value, then the data of equipment parameters and setpoints are synthesized.

In a particular case, the metrics is the integral time of violation of preset restrictions of the values of control parameters of the system, the metrics depends, at this, on, at least, parameters of the building and equipment.

In a particular case, the metrics is the mean time of violation of restrictions of control in preset time interval, the metrics, at that, depends on, at least, parameters of the building and equipment.

In a particular case in the absence of data of parameters and setpoints of equipment the time allotted to generate data of equipment parameters and setpoints is increased.

In a particular case, the heating, ventilation and air conditioning control system is trained employing methods of Model Predictive Control or Reinforcement Learning or systems of equations describing, at least, operation of each equipment unit, the weather data and data of thermophysical processes.

In a particular case, the data to train the heating, ventilation and air conditioning control system are generated using the control method with predictive model (Model Predictive Control), where the predictive model implementing machine learning using classifier or decision trees or regression equations is trained on the data from the database of equipment parameters and setpoints or is made in the form of a system of equations, describing operation of each equipment unit, the weather data and the data of thermophysical processes.

In a particular case, generation of optimal training data set to train heating, ventilation and air conditioning control system at each time step comprises: selection or presetting of the matrix containing information about intervals of the target variable and the quantity of values for the intervals to be collected in the course of generating optimal training data, receiving current equipment parameters, generation of a set of versions of setpoints in the preset neighborhood of values of setpoints with creation of a combination grid of versions of setpoints for further predictive optimality check; for each version of setpoints forming predicted parameters of equipment using combination of setpoints with use of predictive model the following is done: predicted equipment parameters created with use of each of the versions of generated setpoints are determined, setpoints from the set of generated versions of setpoints at which the predicted parameters of equipment satisfy microclimate restrictions and/or by equipment parameters, and at which the pair version of setpoints and current parameters is not available in the data of parameters and setpoints; optimal training setpoints from those selected at the previous step are determined by taking a random value using uniform, normal or exponential random values distribution law; use of determined optimal training setpoints of equipment; addition of the pair of optimal training setpoints and current parameters to the data of equipment parameters and setpoints, check of the necessity of generating optimal training data which is a check of the composition of the target variable preset in the matrix containing information about the intervals of the target variable and the number of their values.

In a particular case, at each time step after the use of optimal setpoints the number of values of the interval of target variable is decremented, predicted when using determined at the current time step optimal setpoints, matrix containing information about target variable intervals and the quantity of values for the intervals.

In a particular case, to determine predicted equipment parameters created with use of each of the versions of generated setpoints, additionally the values of certainty of predicted data is generated, and optimal training setpoints are determined by selection of setpoints at which the predicted parameters of equipment will satisfy the microclimate restrictions and/or by equipment parameters and at which the smallest value of certainty in the predicted data is generated.

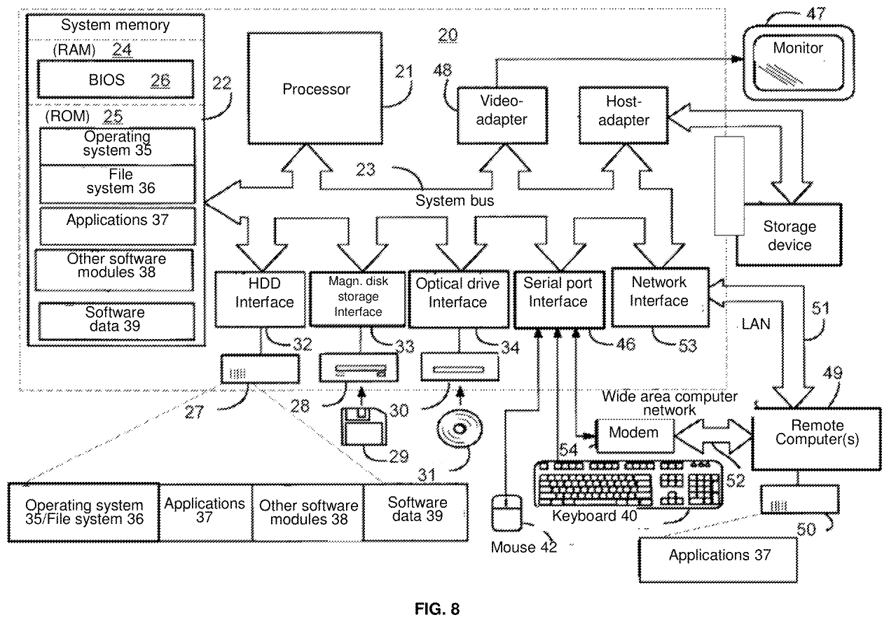

FIG. 8 shows an example of general purpose computer system comprising multipurpose computing device in the form of computer 20 or server comprising processor 21, system memory 22 and system bus 23, connecting various system components, including system memory with processor 21.

System bus 23 can be of any of different type of bus structure, including the memory bus or memory controller, periphery bus and local bus using any of the multitude of bus architectures. The system memory comprises read only memory (ROM) 24 and random-access memory (RAM) 25. ROM 24 stores basic input/output system 26 (BIOS) consisting of main routines helping exchange information between the elements inside computer 20, e.g. at the moment it is started.

Computer 20 can also comprise hard-disk unit 27 to read from and to record onto (not shown), magnetic disk unit 28 to read from and to record onto removable magnetic disk 29 and optical disk storage 30 to read from and to record onto removable optical disk 31 such as a compact disk, digital video disk and other optical media. Hard disk storage 27, magnetic disk storage 28 and optical disk storage 30 are connected with system bus 23 by hard disk storage interface 32, magnetic disk storage interface 33 and optical storage interface 34, respectively. The storages and their respective computer readable media secure nonvolatile storage of computer readable instructions, data structures, software modules and other data for computer 20.

Even though the typical configuration described here uses hard disk, removable magnetic disk 29 and removable optical disk 31 a person skilled in the art will pay attention that in the typical operational environment other types of computer readable media which can store computer accessible data, such as magnetic cassettes, flash memory drives, digital video disks, Bernoulli cartridges, random-access memories (RAM) and read only memories (ROM) and so on can also be used.

Various software modules, including operating system 35 can be stored on hard disk, magnetic disk 29, optical disk 31, ROM 24 or RAM 25. Computer 20 comprises file system 36, connected with operating system 35 or integrated into it, one or more software application 37, other software modules 38 and software data 39. The user can enter commands and information into computer 20 by input devices such a keyboard 40 and pointing device 42. Other input devices (not shown) can comprise microphone, joystick, gamepad, satellite antenna, scanner or anything else.

These and other input devices are connected with processor 21 frequently through interface 46 of the serial port connected with the system bus, but can be connected by other interfaces, such as parallel port, game port or universal serial bus (USB). Monitor 47 or other type of video display unit is also connected with system bus 27 through interface, e.g. videoadapter 48. In addition to monitor 47 personal computers usually comprise other peripheral output devices (not shown) such as speakers and printers.

Computer 20 can operate in network environment through logical connections to one or several remote computers 49. Remote computer (or computers) 49 can be an other computer, server, router, network PC, peer-to-peer device or an other unit of a single network and usually comprises most or all above described elements with respect to computer 20, even though only information storage device 50 is shown. Logical connections comprise local network (LAN) 51 and wide area network (WAN) 52. Such network neighborhoods are common in institutions, corporate computer networks, Internet.

Computer 20 used in network neighborhood LAN is connected with local network 51 by network interface or adapter 53. Computer 20 used in network neighborhood WAN generally uses modem 54 or other means to establish connection with wide area network 52, such as Internet.

Modem 54 which can be either internal or external is connected with system bus 23 through interface 46 of the serial port. In the network neighborhood the software modules or their parts described as applied to computer 20, can be stored in remote storage device. It should be taken into consideration that the mentioned network connections are typical and to establish communication between computers other means can be used.

In conclusion it should be noted that the information given in the description are examples which do not limit the scope of this technical solution defined by the claims. A person skilled in the art understands that there may exist other embodiments of this technical solution in agreement with the essence and scope of this technical solution.

We claim:

1. A method of controlling a heating, ventilation and air conditioning control system wherein:
selecting metrics of defining accuracy of controlling the heating, ventilation and air conditioning (HVAC) control system;
receiving data of parameters and setpoints of equipment from building management system and storing in the database of equipment parameters and setpoints and sets of data from data generation controller generating optimal training data to train HVAC control system and storing them after generation;
training data generation controller and HVAC equipment control system using data from the database of equipment parameters and setpoints;
putting HVAC equipment control system into operation;
determining value of current accuracy of controlling the heating, ventilation and air conditioning control system depending on the selected metrics of computing the accuracy of controlling the heating, ventilation and air conditioning control system and checking sufficiency of accuracy of controlling the heating, ventilation and air conditioning control system by preset value of threshold value;
continuing to receive in response to the value of accuracy of controlling HVAC equipment control system below the preset threshold value which corresponds to sufficiency of accuracy of controlling HVAC equipment control system the data of equipment parameters and setpoints from the building management system and data generation controller and storing in the database of equipment parameters and setpoints;
in response to the value of accuracy of controlling HVAC equipment control system above the preset threshold value which corresponds to insufficiency of accuracy of controlling HVAC equipment control system performing the following steps until the required value of accuracy of controlling HVAC equipment control system is achieved:
selecting type of distribution and parameters of distribution for the target requiring optimization variable;
putting HVAC equipment control system out of operation;
putting into operation data generation controller and using the data generation controller generate optimal training data achieving the quantity and composition of the target variable in the generated data according to the selected type of distribution and parameters of distribution of the target variable, after which putting the data generation controller out of operation;
additionally training machine learning models of the HVAC equipment control system on all data from the database of equipment parameters and setpoints;
putting into operation additionally trained HVAC equipment control system and determining the value of accuracy of controlling of the HVAC equipment control system depending on the selected metrics and checking sufficiency of accuracy of controlling of the HVAC equipment control system by means of preset value of threshold value, if the value of accuracy of controlling the HVAC control system is, at that, below preset threshold value, continuing receiving the data of equipment parameters and setpoints from the building management system and data generation controller and storing in the database of equipment parameters and setpoints, and if the value of accuracy of controlling the HVAC equipment control system is above the preset threshold value, synthesizing the data of equipment parameters and setpoints.

2. Method of claim 1 wherein the metrics is the integral time of violation of preset restrictions of the values of control system parameters, the metrics depending, at this, at least, on parameters of the building and equipment.

3. Method of claim 1 wherein the metrics is the mean time of violation of restrictions of control in preset time interval the metrics, at this, depends, at least on parameters of the building and equipment.

4. Method of claim 1 wherein in the absence of data of equipment parameters and setpoints the time allotted to generate the data of equipment parameters and setpoints is increased.

5. Method of claim 1 wherein the heating, ventilation and air conditioning control system is trained using Model Predictive Control or Reinforcement Learning methods or systems of equations describing, at least, the operation of each equipment unit, the data of weather and thermophysical processes.

6. Method of claim 1 wherein the data to train the heating, ventilation and air conditioning control system are generated using a method of controlling with predictive model (Model Predictive Control) where to implement machine learning with use of classifier or decision trees or regression equations the predictive model is trained on the data from the database of equipment parameters and setpoints or is made in the form of the system of equations describing operation of each equipment unit, the data of weather and thermophysical processes.

7. Method of claim 1 wherein generation of set of data optimal for training the heating, ventilation and air conditioning control system at each time step comprises:
selecting or setting matrix containing information about intervals of the target variable and the number of values for the intervals which are to be collected in the course of generating optimal training data,
obtaining current parameters of the equipment,
generating a set of versions of setpoints in preset neighborhood of values of setpoints with creation of combination grid of versions of setpoints for further predictive optimality check;
for each version of setpoints creating predicted parameters of equipment with application of a combination of setpoints with use of predictive model the following is done:
creating predicted parameters of equipment created determining in the use of each of the versions of generated setpoints,
selecting setpoints from the set of generated versions of setpoints at which the predicted parameters of equipment satisfy restrictions of microclimate and/or by equipment parameters, and at which the pair version of rules and current parameters is not available in the data of parameters and setpoints are selected;
determining optimal for training setpoints from those selected at the previous step by taking a random value with use of uniform, normal or exponential random values distribution law;
using determined optimal for training setpoints of equipment; adding the pair of optimal for training rules and current parameters to the data of parameters and setpoints of equipment,
checking necessity of generating optimal training data, this is the check of the composition of the target variable set in the matrix containing information about the intervals of target variable and number of their values.

8. Method of claim 7 wherein at each time step after the use of optimal setpoints decremented is the number of values of the interval of the target value predicted using determined at the current time step optimal setpoints, matrix containing information about the intervals of the target variable and the number of values of the interval.

9. Method of claim 8 wherein during determination of predicted parameters of equipment created using each of the versions of generated setpoints additionally the value of certainty in predicted data is generated and optimal training setpoints are determined by selection of setpoints at which the predicted parameters of equipment satisfy the restrictions of microclimate and/or by equipment parameters at which the smallest value of certainty in predicted data is generated.
